(19) United States
(12) Patent Application Publication
(10) Pub. No.: US 2018/0107962 A1
(43) Pub. Date: Apr. 19, 2018

(54) STRESS AND PRODUCTIVITY INSIGHTS BASED ON COMPUTERIZED DATA

(71) Applicant: Microsoft Technology Licensing, LLC, Redmond, WA (US)

(72) Inventors: Jessica Lundin, Seattle, WA (US); Ryen William White, Woodinville, WA (US); Girish Nathan, Sammamish (WA); Tachen Ni, Bellevue, WA (US)

(21) Appl. No.: 15/294,539

(22) Filed: Oct. 14, 2016

(51) Int. Cl. G06Q 10/06; G06N 5/04

(52) U.S. Cl. CPC G06Q 10/06398; G06N 5/04

(57) ABSTRACT

Determining stress and productivity insights based on computerized data is described. Productivity data and stress-related behavior data associated with a user may be determined. The stress-related behavior data may be based on sensor data received from sensor(s) associated with a device corresponding to the user. The stress-related behavior data may be utilized to determine a first value indicative of stress associated with the user and the productivity data may be utilized to determine a second value indicative of productivity of the user. The productivity data, the stress-related behavior data, the first value, and/or the second value may be utilized to determine a recommendation. The recommendation may be intended to modify the first value and/or the second value. A user interface configured to communicate the recommendation to the user may be presented via the device.

### BACKGROUND

Electronic devices, such as wearables and smart phones, may be configured to track and output information regarding physiological and behavioral characteristics of a person, such as health data and fitness data. Additionally, electronic devices provide email services, electronic calendar services, social networking services, etc. Information associated with email services, electronic calendar services, social networking services, etc. may also be used to determine information regarding physiological and behavioral characteristics of a person. Currently, the information regarding physiological and behavioral characteristics that is available does not provide insights with respect to stress and productivity of a person. Additional insights that would be meaningful for a person regarding stress and productivity remain unavailable and/or inaccessible.

### SUMMARY

This disclosure describes determining stress and productivity insights based on computerized data and making recommendations based on the stress and productivity insights. Productivity data and stress-related behavior data associated with a user may be determined. In at least one example, productivity data may be based on data associated with email services, electronic calendar services, social networking services, etc., provided via a device associated with the user. In some examples, stress-related behavior data may be based on sensor data received from sensor(s) associated with the device associated with the user. The stress-related behavior data may be utilized to determine a first value indicative of stress associated with the user and the productivity data may be utilized to determine a second value indicative of productivity of the user.

In at least one example, the productivity data, the stress-related behavior data, the first value, and/or the second value may be utilized to determine a recommendation associated with a health activity, a change to an environment associated with the user, and/or a change to an activity that generates at least some productivity data. For instance, based at least in part on determining that the first value is above a threshold, a recommendation may be determined to decrease the first value, and accordingly reduce the stress associated with the user. Alternatively, based at least in part on determining that the first value is below a threshold, a recommendation may be determined to increase the first value, and accordingly increase the stress associated with the user. Moreover, based at least in part on determining that the second value is below a threshold, a recommendation may be determined to increase the second value, and accordingly increase the productivity of the user. Alternatively, based at least in part on determining that the second value is above a threshold, a recommendation may be determined to decrease the second value, and accordingly decrease the productivity of the user. In some examples, the recommendation may be associated with an action. A user interface configured to communicate the recommendation, and in some examples the action, to the user may be presented to the user via the device.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of techniques in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a schematic diagram showing an example environment for determining stress and productivity insights based on computerized data.

FIG. 2 is a schematic diagram showing additional details associated with the example environment for determining stress and productivity insights based on computerized data described above with reference to FIG. 1.

FIG. 3A is a schematic diagram showing an example user interface for presenting stress insights via a device.

FIG. 3B is a schematic diagram showing an example user interface for presenting productivity insights via a device.

FIG. 3C is a schematic diagram showing an example user interface for presenting stress and/or productivity insights and a recommendation via a device.

FIG. 3D is a schematic diagram showing an example user interface for presenting stress and/or productivity insights via a device.

FIG. 4 is a flow diagram that illustrates an example process to determine a recommendation based on determined stress and productivity insights.

FIG. 5 is a flow diagram that illustrates an example process to facilitate execution of an action associated with a recommendation based on determined stress and productivity insights.

FIG. 6 is a flow diagram that illustrates a process for providing feedback to update a recommendation model for determining recommendations based on determined stress and productivity insights.

### DETAILED DESCRIPTION

This disclosure describes determining stress and productivity insights based on computerized data and determining recommendations based on the stress and productivity insights. For example, techniques described herein include determining and/or predicting stress associated with a user based on data indicative of the user's health, activity, and environment. In some examples, techniques described herein include utilizing productivity data associated with a user to determine and/or predict stress associated with the user and making recommendations to modify the stress associated with the user. Additionally, in at least one example, techniques described herein include determining and/or predicting the productivity of a user based on data indicative of the user's health and environment. In some examples, techniques described herein include using stress-related behavior data associated with a user to determine and/or predict productivity of a user and make recommendations to modify the productivity associated with the user.

As described above, in at least one example, techniques described herein may leverage productivity data and/or stress-related behavior data to determine recommendations to determine recommendations to increase stress and/or productivity and/or decrease stress and/or productivity. In at least one example, the recommendations described herein may be associated with changes to the user's health, activity, and/or environment. As described below, recommendations may be specific to a user, a cohort of users, or a population of users. For the purpose of this discussion, a cohort of users may be a group of users that have at least one characteristic in common. For instance, each of the users in the cohort of users may be associated with a same geographic location, a same gender, a same race, a same age, a same health condition, a same occupation, etc. Moreover, for the purpose of this discussion, a population of users may correspond to all users for which a service provider receives data.

As a non-limiting example, a recommendation, as described herein, may include scheduling a yoga class or a massage at a particular time to reduce stress, and in turn, increase productivity. Additionally and/or alternatively, a recommendation may include powering down all computing devices one hour prior to when a user goes to bed to improve the user's sleep quality and/or duration, thereby reducing stress and increasing productivity. Moreover, a recommendation may include turning down the temperature in the environment surrounding the user to decrease stress and increase productivity.

The techniques described herein provide various improvements to computing devices and/or computing capabilities. For instance, in at least one example, a recommendation for modifying stress and/or productivity may be associated with a health activity (e.g., take a walk, attend a yoga class, patronize the spa, etc.). In such examples, techniques described herein may control a power state associated with at least one device associated with a user. For instance, based at least in part on the recommendation, a computing device may enter a power save mode at a time associated with the recommendation because the computing device may recognize that the user cannot be interacting with the computing device and participating in the health activity associated with the recommendation at the same time. In at least one example, at a same time that the computing device enters a power save mode, the computing device may perform updates, empty cache storage, and otherwise refresh the computing device. As a result, when the user returns to his or her computing device, the computing device may be performing better than before the computing device went into power save mode. Additionally and/or alternatively, the computing device may cease acquisition of some or all sensor data, or otherwise decrease the power consumption of the computing device at the same time that a user participates in a health activity.

Additionally, in at least one example, a recommendation for modifying stress and/or productivity may be associated with a recommendation to reduce the amount of time that a user interacts with his or her computing device. For instance, a recommendation may suggest that a user not interact with his or her device for at least 30 minutes prior to his or her bed time (e.g., to improve sleep quality and/or duration, thereby reducing stress and increasing productivity). Or, a recommendation may suggest that a user respond to emails during a particular window of the day instead of responding to emails throughout the day (e.g., to decrease fragmentation of the day, thereby reducing stress and increasing productivity). In both examples, such recommendations may reduce the amount of time a user interacts with his or her computing device. As a result, such recommendations may amount to energy conservation for the computing device.

### Illustrative Environments

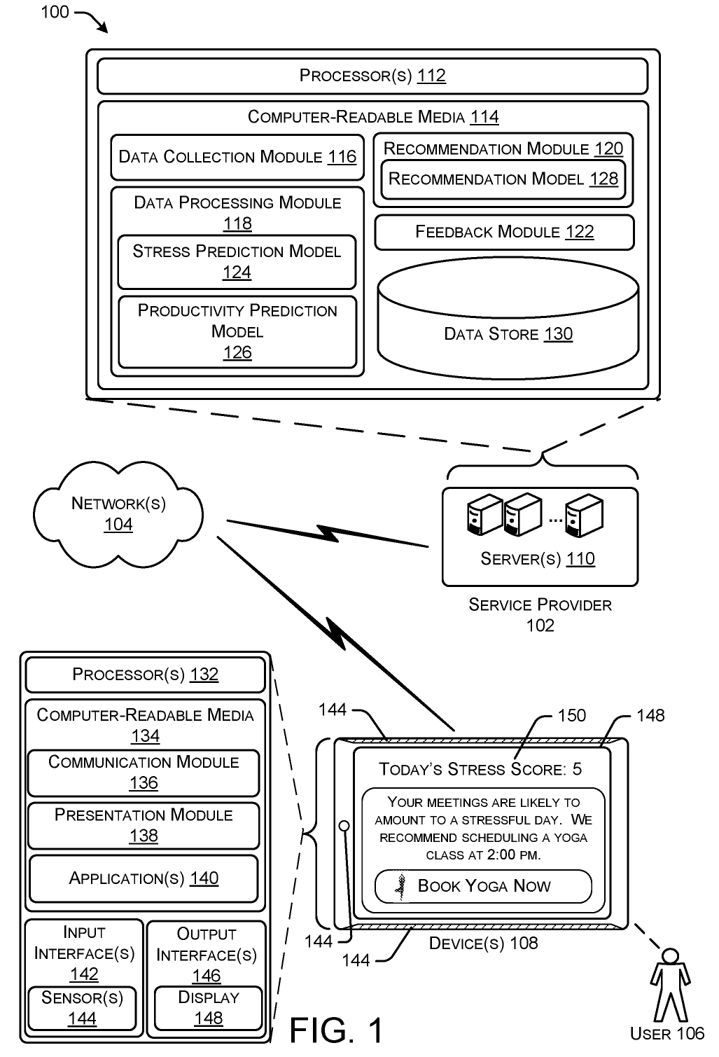

FIG. 1 is a schematic diagram showing an example environment 100 for determining stress and productivity insights based on computerized data. More particularly, the example environment 100 may include a service provider 102, network(s) 104, a user 106, and one or more devices 108 associated with the user 106.

The service provider 102 may be any entity, server(s), platform, etc., that accesses computerized data associated with the user 106 and determines stress and productivity insights associated with the user 106 based on the computerized data. The service provider 102 may receive data from the one or more devices 108 (i.e., computerized data) and may determine at least productivity data and stress-related behavior data based on the data. The service provider 102 may leverage the productivity data and/or stress-related behavior data to determine a recommendation to decrease stress and/or increase productivity. The service provider 102 may cause the recommendation to be presented to the user 106 via a device of the one or more devices 108. The service provider 102 may be implemented in a non-distributed computing environment or may be implemented in a distributed computing environment, possibly by running some modules on remotely located devices (e.g., a device of the one or more devices 108).

In at least one example, the service provider 102 may include one or more servers 110. The network(s) 104 may facilitate communication between the server(s) 110 and the one or more devices 108 associated with the user 106. The server(s) 110 and/or the one or more devices 108 may communicatively couple to the network(s) 104 in any manner, such as by a global or local wired or wireless connection (e.g., local area network (LAN), intranet, etc.). In some examples, the network(s) 104 may be any type of network known in the art, such as the Internet.

Examples support scenarios where device(s) that may be included in the one or more servers 110 may include one or more computing devices that operate in a cluster or other configuration to share resources, balance load, increase performance, provide fail-over support or redundancy, or for other purposes. Device(s) that may be included in the one or more servers 110 may include any type of computing device having processor(s) 112 operably connected to computer-readable media 114 such as via a bus, which in some instances may include one or more of a system bus, a data bus, an address bus, a PCI bus, a Mini-PCI bus, and any variety of local, peripheral, and/or independent buses. In at least one configuration, the computer-readable media 114 of the server(s) 110 may include module(s) for receiving data associated with the user 106, determining stress and productivity insights based on the data, and determining a recommendation based on the stress and productivity insights. Alternatively, or in addition, the functionality described herein may be performed, at least in part, by one or more hardware logic components such as accelerators. For example, and without limitation, illustrative types of hardware logic components that may be used include Field-Programmable Gate Arrays (FPGAs), Application-Specific Integrated Circuits (ASICs), Application-Specific Standard Products (ASSPs), System-on-a-Chip Systems (SOCs), Complex Programmable Logic Devices (CPLDs), etc.

Processor(s) 112 may represent, for example, a CPU-type processing unit, a GPU-type processing unit, a Field-Programmable Gate Array (FPGA), another class of Digital Signal Processor (DSP), or other hardware logic components that may, in some instances, be driven by a CPU. For example, and without limitation, illustrative types of hardware logic components that may be used include Application-Specific Integrated Circuits (ASICs), Application-Specific Standard Products (ASSPs), System-on-a-Chip systems (SOCs), Complex Programmable Logic Devices (CPLDs), etc. In various examples, the processor(s) 112 may execute one or more modules and/or processes to cause the server(s) 110 to perform a variety of functions, as set forth above and explained in further detail in the following disclosure. Additionally, each of the processor(s) 112 may possess its own local memory, which also may store program modules, program data, and/or one or more operating systems.

As described above, in at least one configuration, the computer-readable media 114 of the server(s) 110 may include module(s) for receiving data associated with the user 106, determining stress and productivity insights based on the data, and determining a recommendation based on the stress and productivity insights. The module(s) may represent pieces of code executing on a computing device. In some examples, a module may include an Application Program Interface (API) to perform some or all of its functionality (e.g., operations). In additional and/or alternative examples, the module(s) may be implemented as computer-readable instructions, various data structures, and so forth via at least one processing unit (e.g., processor(s) 112) to configure a device to execute instructions and to perform operations described herein. Functionality to perform these operations may be included in multiple devices or a single device. The module(s) may include a data collection module 116, a data processing module 118, a recommendation module 120, and a feedback module 122.

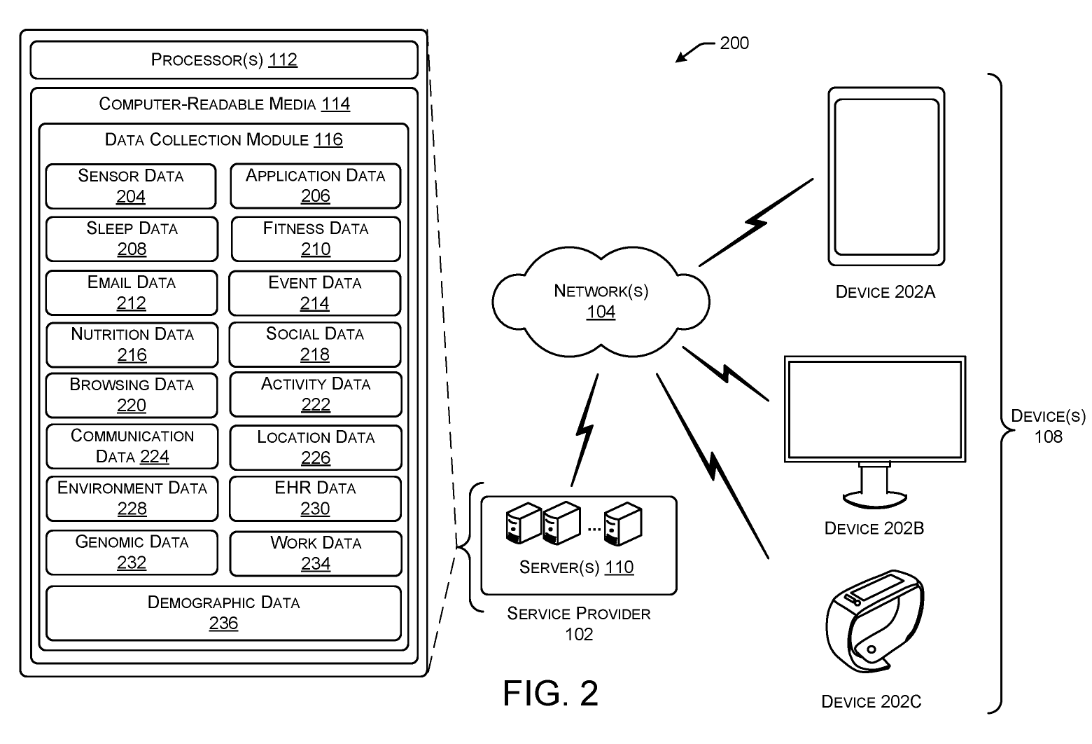

The data collection module 116 may be configured to access, receive, and/or determine data associated with the user 106 and/or an environment associated with the user 106. In at least one example, the data collection module 116 may access and/or receive data from the device(s) 108. Such data may include sensor data, application data, location data, etc. In at least one example, the data collection module 116 may leverage the sensor data, application data, location data, etc. to determine productivity data and/or stress-related behavior data. In additional and/or alternative examples, the data collection module 116 may access and/or receive data from third-party sources and/or systems. Additional details associated with the data collection module 116 are described below with reference to FIG. 2.

The data processing module 118 may be configured to access and/or receive the data from the data collection module 116 and may process the data to determine stress and/or productivity insights. In at least one example, the data processing module 118 may utilize a stress prediction model 124 to determine a value representative of stress associated with a user 106. Additionally, the data processing module 118 may utilize a productivity prediction model 126 to determine a value representative of productivity of the user 106. In at least one example, the value representative of stress associated with a user 106 may be based at least in part on productivity data and the value representative of productivity of the user 106 may be based at least in part on stress-related behavior data. That is, in at least one example, stress and productivity may be coupled.

The stress prediction model 124 may be a machine-learning algorithm trained to determine a value representative of stress associated with a user 106 based on various data inputs. The data inputs may include at least productivity data and/or stress-related behavior data. The stress prediction model 124 may account for certain data items that affect stress more than other data items by weighting different data items differently. That is, in at least one example data items that affect stress more than other data items may be associated with a larger weight than data items that have little or no effect on stress. As described above, the stress prediction model 124 may output a value representative of stress associated with a user 106. For the purpose of this discussion, the value indicative of the stress of a user 106 may be referred to as a stress score.

A stress score may correspond to a particular period of time. For instance, the stress prediction module 124 may determine a stress score for a particular hour, day, week, month, etc. In some examples, a stress score may represent current stress associated with a user 106. In other examples, a stress score may represent a prediction of future stress associated with a user 106. In at least one example, a stress score associated with current stress of a user 106 may be based on a different set of data inputs than a stress score associated with a prediction of future stress associated with the user 106. For instance, a stress score associated with current stress of a user 106 may be based on data inputs from two days prior to the current day and two days succeeding the current day and a stress score associated with a prediction of future stress associated with the user 106 may be based on data inputs associated with days preceding and/or succeeding the future day for which the stress score is being determined. In additional and/or alternative examples, the data inputs may be the same data inputs; however, individual of the data inputs may be associated with weights based on timing associated with individual of the data inputs. For instance, an event on an upcoming Thursday may affect a stress score associated with a user 106 on Monday less than a stress score associated with the user 106 on Wednesday or Thursday. Accordingly, data associated with the event may be associated with a weight that increases as the user 106 gets closer to the day of the event and/or decreases as the user 106 gets farther away from the day of the event.

A stress score can correspond to a value in a range of values. The range of values may represent the range of stress wherein a number below a threshold may indicate that a user 106 is not stressed and/or is not likely to be stressed and a number above a threshold may indicate that a user 106 is stressed and/or is likely to be stressed. In at least one example, the threshold may be static. In other examples, the threshold may be dynamic. In at least one example, the threshold may be specific to a user 106, a cohort of users, or a population of users. Additionally or alternatively, a stress score in the range of values may represent a degree of stress associated with a user 106. As a non-limiting example, the range of values may be values from 0-6. A stress score of 0 may indicate that a user is not stressed and/or is not likely to be stressed. A stress score of 6 may indicate that the user is extremely stressed and/or is likely to be extremely stressed. In some examples, individual ranges of values within the range of values may represent levels of stress. For instance, for the range of values of 0-6, a first range (0-2) may indicate that a user is not stressed and/or is not likely to be stressed, a second range (3-4) may indicate that a user is moderately stressed and/or is likely to be moderately stressed, and a third range (5-6) may indicate that a user is extremely stressed and/or is likely to be extremely stressed.

The stress prediction model 124 may be trained using supervised learning algorithms (e.g., artificial neural networks, Bayesian statistics, gradient boosting trees, support vector machines, decision trees, random forests, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc. In at least one example, the stress prediction model 124 may be trained on productivity data associated with at least one user and/or stress-related behavior data associated with the at least one user and stress scores associated with the at least one user.

In at least one example, the stress prediction model 124 may be specific to the user 106. In such an example, the stress prediction model 124 may be trained on productivity data associated with the user 106 and/or stress-related behavior data associated with the user 106 and stress scores associated with the user 106. In another example, the stress prediction model 124 may be specific to a cohort of users. In such examples, the stress prediction model 124 may be trained on productivity data associated with the cohort of users and/or stress-related behavior data associated with the cohort of users and stress scores associated with the cohort of users. In yet another example, the stress prediction model 124 may be specific to a population of users. In such examples, the stress prediction model 124 may be trained on productivity data associated with the population of users and/or stress-related behavior data associated with the population of users and stress scores associated with the population of users.

The productivity prediction model 126 may be a machine-learning algorithm trained to determine a value representative of productivity of a user 106 based on various data inputs. The data inputs may include at least productivity data and/or stress-related behavior data. In some examples, the productivity prediction model 126 may utilize at least some of the same data inputs as the stress prediction model 124. In other examples, the productivity prediction model 126 may utilize different data inputs than the stress prediction model 124. The productivity prediction model 126 may account for certain data items that affect productivity more than other data items by weighting different data items differently. That is, in at least one example data items that affect productivity more than other data items may be associated with a larger weight than data items that have little or no effect on productivity. As described above, the output may be a value representative of productivity associated with a user 106. For the purpose of this discussion, the value indicative of the productivity of a user 106 may be referred to as a productivity score.

A productivity score may correspond to a particular period of time. For instance, the productivity prediction module 126 may determine a productivity score for a particular hour, day, week, month, etc. In some examples, a productivity score may represent current productivity associated with a user 106. In other examples, a productivity score may represent a prediction of future productivity associated with a user 106. In at least one example, a productivity score associated with current productivity of a user 106 may be based on a different set of data inputs than a productivity score associated with a prediction of future productivity associated with the user 106. For instance, a productivity score associated with current productivity of a user 106 may be based on data inputs from two days prior to the current day and two days succeeding the current day and a productivity score associated with a prediction of future productivity associated with the user 106 may be based on data inputs associated with days preceding and/or succeeding the future day for which the productivity score is being determined. In additional and/or alternative examples, the data inputs may be the same data inputs; however, individual of the data inputs may be associated with weights based on timing associated with individual of the data inputs. For instance, an event on an upcoming Thursday may affect a productivity score associated with a user 106 on Monday less than a productivity score associated with the user 106 on Wednesday or Thursday. Accordingly, data associated with the event may be associated with a weight that increases as the user 106 gets closer to the day of the event and/or decreases as the user 106 gets farther away from the day of the event.

A productivity score can correspond to a value in a range of values. The range of values may represent the range of productivity wherein a number below a threshold may indicate that a user has not been and/or is not likely to be productive and a number above a threshold may indicate that a user has been and/or is likely to be productive. In at least one example, the threshold may be static. In other examples, the threshold may be dynamic. In at least one example, the threshold may be specific to a user 106, a cohort of users, or a population of users. Additionally or alternatively, a productivity score in the range of values may represent a degree of productivity associated with a user 106. As a non-limiting example, the range of values may be values from 1-7. A productivity score of 1 may indicate that a user has not been and/or is not likely to be productive. A productivity score of 7 may indicate that the user has been and/or is likely to be extremely productive. In some examples, individual ranges of values within the range of values may represent levels of productivity. For instance, for the range of values of 1-7, a first range (1-2) may indicate that a user has not been and/or is not likely to be productive, a second range (3-4) may indicate that a user has been and/or is likely to be moderately productive, and a third range (5-7) may indicate that a user has been and/or is likely to be extremely productive.

The productivity prediction model 126 may be trained using supervised learning algorithms (e.g., artificial neural networks, Bayesian statistics, gradient boosting trees, support vector machines, decision trees, random forests, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc. In at least one example, the productivity prediction model 126 may be trained on productivity data associated with at least one user and/or stress-related behavior data associated with the at least one user and productivity scores of the at least one user.

In at least one example, the productivity prediction model 126 may be specific to the user 106. In such an example, the productivity prediction model 126 may be trained on productivity data associated with the user 106 and/or stress-related behavior data associated with the user 106 and productivity scores of the user 106. In another example, the productivity prediction model 126 may be specific to a cohort of users. In such an example, the productivity prediction model 126 may be trained on productivity data associated with the cohort of users and/or stress-related behavior data associated with the cohort of users and productivity scores of the cohort of users. In yet another example, the productivity prediction model 126 may be specific to the population of users. In such an example, the productivity prediction model 126 may be trained on productivity data associated with the population of users and/or stress-related behavior data associated with the population of users and productivity scores associated with the population of users.

The recommendation module 120 may determine recommendation(s) to modify stress and/or productivity based at least in part on productivity data, stress-related behavior data, etc. For instance, the recommendation(s) may intend to increase and/or decrease stress and/or increase and/or decrease productivity. In at least one example, the recommendation module 120 may apply a recommendation model 128 to productivity data associated with the user 106, stress-related behavior data associated with the user 106, a stress score associated with a user 106, and/or a productivity score associated with the user 106 to determine one or more recommendations. A recommendation may correspond to a health activity that the user 106 can participate in, a change to an environment of the user 106, and/or a change to an activity that generates at least some productivity data to modify stress and/or productivity. Additionally, the recommendation module 120 may be configured to determine an action associated with a recommendation. In an example, an action may effectuate the recommendation. For instance, an action may include scheduling an appointment (e.g., a yoga class, a massage, etc.) at a particular time and/or place to modify stress and productivity. In an additional and/or alternative example, an action may correspond to re-scheduling a particular event to modify stress and/or productivity. Additional and/or alternative actions may be imagined.

The recommendation model 128 may be a machine-learning algorithm trained to determine recommendation(s) to modify stress and/or productivity. The recommendation model 128 may be trained using supervised learning algorithms (e.g., artificial neural networks, Bayesian statistics, gradient boosting trees, support vector machines, decision trees, random forests, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc. In at least one example, the recommendation model 128 may be trained on productivity data associated with at least one user, stress-related behavior data associated with the at least one user, stress scores associated with the at least one user, productivity scores associated with the at least one user, and one or more health activities, changes to an environment associated with the at least one user, and/or changes to activities that generate productivity data that the at least one user engaged in that resulted in modifications to stress and/or productivity.

In at least one example, the recommendation model 128 may be specific to the user 106. In such an example, the recommendation model 128 may be trained on productivity data associated with the user 106, stress-related behavior data associated with the user 106, stress scores of the user 106, productivity scores of the user 106, and one or more health activities, changes to an environment associated with the user 106, and/or changes to activities that generate productivity data that the user 106 engaged in that resulted in modifications to stress and/or productivity. In another example, the recommendation model 128 may be specific to a cohort of users. In such an example, the recommendation model 128 may be trained on productivity data associated with the cohort of users, stress-related behavior data associated with the cohort of users, stress scores of the cohort of users, productivity scores of the cohort of users, and one or more health activities, changes to an environment associated with the cohort of users, and/or changes to activities that generate productivity data that the cohort of users engaged in that resulted in modifications to stress and/or productivity. In yet another example, the recommendation model 128 may be specific to a population of users. In such an example, the recommendation model 128 may be trained on productivity data associated with the population of users, stress-related behavior data associated with the population of users, stress scores of the population of users, productivity scores of the population of users, and one or more health activities, changes to an environment associated with the population of users, and/or changes to activities that generate productivity data that the population of users engaged in that resulted in modifications to stress and/or productivity.

In at least one example, the recommendation module 120 may provide recommendations to the one or more devices 108 to facilitate presenting the recommendations to the user 106. The recommendation module 120 may provide recommendations to the one or more devices 108 reactively (responsive to a request from a user 106 to determine a recommendation), proactively (without a request from a user 106), at a particular frequency, after a lapse of a predetermined period of time, etc. The recommendation module 120 may cause the recommendations to be presented via the one or more devices 108 as a taskbar tease, a push notification, an email, etc.

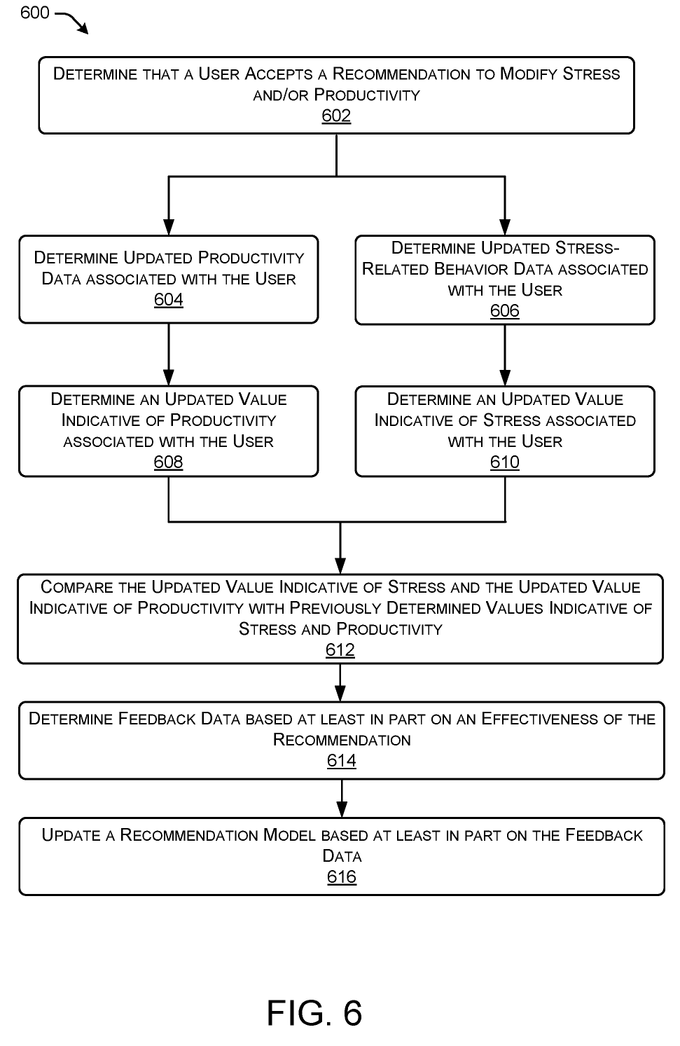

The feedback module 122 may be configured to determine an effectiveness of a recommendation and may determine feedback data based on the effectiveness of the recommendation. The feedback module 122 may provide the feedback data to the recommendation module 120 for improving the recommendation model 128. Additional details associated with generating feedback data for updating the recommendation model 128 are described below with reference to FIG. 6.

Additionally, the computer-readable media 114 may include a data store 130. The data store 130 may be configured to store data that is organized so that it can be accessed, managed, and updated. In at least one example, the data store 130 may include a user profile associated with the user 106. The one or more data items may be mapped to, or otherwise associated with, the user profile. For example, productivity data and/or stress-related behavior data may be mapped to, or otherwise associated with, the user profile. Additional user profiles respectively corresponding to additional users may also be stored in the data store 130.

Depending on the exact configuration and type of the server(s) 110, computer-readable media 114, may include computer storage media and/or communication media. Computer storage media may include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that may be used to store and maintain information for access by a computing device.

In contrast, communication media may embody computer readable instructions, data structures, program modules, or other data in a modulated data signal, such as a carrier wave, or other transmission mechanism. The term “modulated data signal” means a signal that has one or more of its characteristics set or changed in such a manner as to encode information in the signal. Such signals or carrier waves, etc. may be propagated on wired media such as a wired network or direct-wired connection, and/or wireless media such as acoustic, RF, infrared and other wireless media. As defined herein, computer storage media does not include communication media. That is, computer storage media does not include communications media consisting solely of a modulated data signal, a carrier wave, or a propagated signal, per se.

As described above, user 106 may operate one or more devices 108. The one or more devices 108 may be any device type and the one or more devices 108 are not limited to any particular type of device. Examples of the one or more devices 108 may include but are not limited to stationary computers, mobile computers, embedded computers, or combinations thereof. Example stationary computers may include desktop computers, work stations, personal computers, thin clients, terminals, game consoles, personal video recorders (PVRs), set-top boxes, or the like. Example mobile computers may include laptop computers, tablet computers, wearable computers, implanted computing devices, telecommunication devices, automotive computers, portable gaming devices, media players, cameras, or the like. Example embedded computers may include network enabled televisions, integrated components for inclusion in a computing device, appliances, microcontrollers, digital signal processors, or any other sort of processing device, or the like.

In at least one example, device(s) 108 may include processor(s) 132 and computer-readable media 134. In such examples, the processor(s) 132 may have a same composition and functionality as processor(s) 112, the computer-readable media 134 may have a same composition and functionality as computer-readable media 114. In at least one configuration, the computer-readable media 134 of the device may include module(s) for communicating with the service provider 102 and presenting stress and productivity insights—and corresponding recommendation(s)—via the device(s) 108.

In examples where the computer-readable media 134 includes module(s), the module(s) may represent pieces of code executing on a computing device. In some examples, a module may include an Application Program Interface (API) to perform some or all of its functionality (e.g., operations). In additional and/or alternative examples, the module(s) may be implemented as computer-readable instructions, various data structures, and so forth via at least one processing unit (e.g., processor(s) 132) to configure a device to execute instructions and to perform operations described herein. Functionality to perform these operations may be included in multiple devices or a single device. The module(s) may include a communication module 136 and a presentation module 138. Additionally, the computer-readable media 134 may include one or more applications 140.

The communication module 136 may send data to the service provider 102 and receive data from the service provider 102. In at least one example, the communication module 136 may send sensor data received from one or more sensors, described below, to the service provider 102. Moreover, in at least one example, the communication module 136 may send application data associated with the one or more applications 140 to the service provider 102. Additionally and/or alternatively, in at least one example, the communication module 136 may send location data associated with the device(s) 108 to the service provider 102. Additionally, the communication module 136 may receive data associated with stress and/or productivity insights, recommendations, actions, etc. from the service provider 102.

The presentation module 138 may determine how to present data associated with stress and/or productivity insights, recommendations, actions, etc. via a user interface. In at least one example, the presentation module 138 may generate a user interface for presenting data associated with stress and/or productivity insights, recommendations, actions, etc. Additionally, the presentation module 138 may present the user interface to communicate the stress and/or productivity insights, recommendations, actions, etc. to the user 106.

The application(s) 140 may be created by programmers to fulfill specific tasks and/or perform specific functionalities. For example, applications may provide utility, entertainment, educational, and/or productivity functionalities to the user 106 of the one or more devices 108. Applications may be built into a device (e.g., telecommunication, text message, clock, camera, etc.) or may be customized (e.g., games, news, transportation schedules, online shopping, etc.). In at least one example, an application of the application(s) 140 may be a fitness tracking application, a sleep tracking application, a nutrition tracking application, a health application, etc. Additionally and/or alternatively, an application of the application(s) 140 may be a messaging application, an email application, a calendar application, a social networking application, a web browser application, etc.

As described above, the device 102 may include the input interface(s) 142 and output interface(s) 146. The input interface(s) 142 may enable input via a keyboard, keypad, mouse, microphone, touch sensor, touch screen, joystick, control buttons, scrolling buttons, cameras, or any other device suitable to generate a signal and/or data defining a user interaction with the device 102. In at least one example, the input interface(s) 142 may include one or more sensors 144 for collecting sensor data corresponding to physiological and/or behavioral information about the user 106.

In at least one example, the sensor(s) 144 can be any device or combination of devices configured to physiologically monitor a user 106. The sensor(s) 144 can include, but are not limited to, a galvanic skin response sensor for measuring galvanic skin response, a skin temperature sensor for measuring the temperature on the surface of the skin, an electroencephalography (EEG) device for measuring electrical activity of the brain, an electrocardiography (ECG or EKG) device for measuring electrical activity of the heart, cameras for tracking eye movement, facial expressions, pupil dilation and/or contraction, etc., sound sensors for measuring a volume of speech, a rate of speech, etc., etc. In some examples, the sensor(s) 144 may include an accelerometer for measuring movement in multiple directions, a gyroscope for measuring orientation and rotation, an altimeter for measuring altitude, etc. In additional and/or alternative examples, one or more of the sensor(s) 144 may be associated with location systems for determining location data and/or environment systems for determining environment data, as described below.

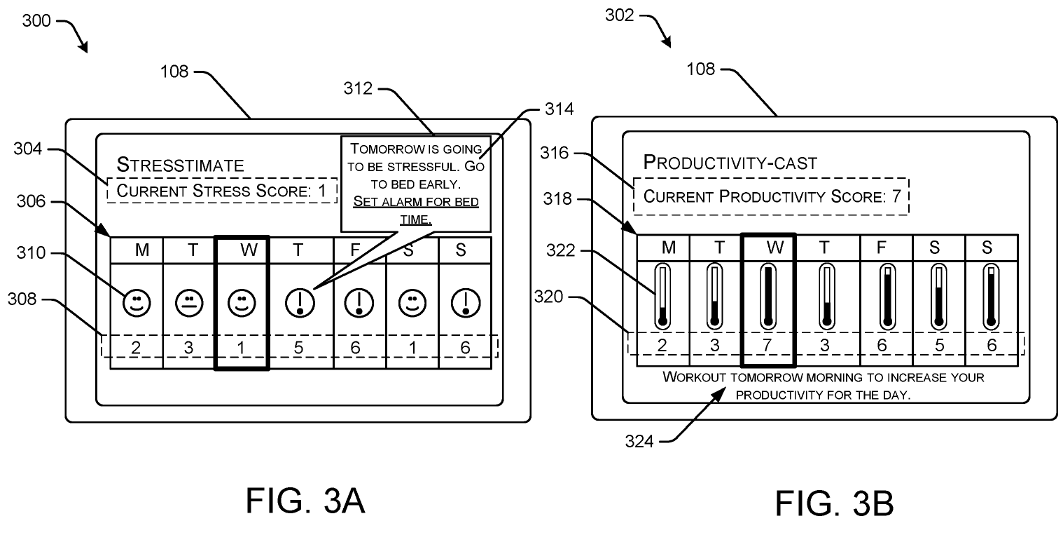

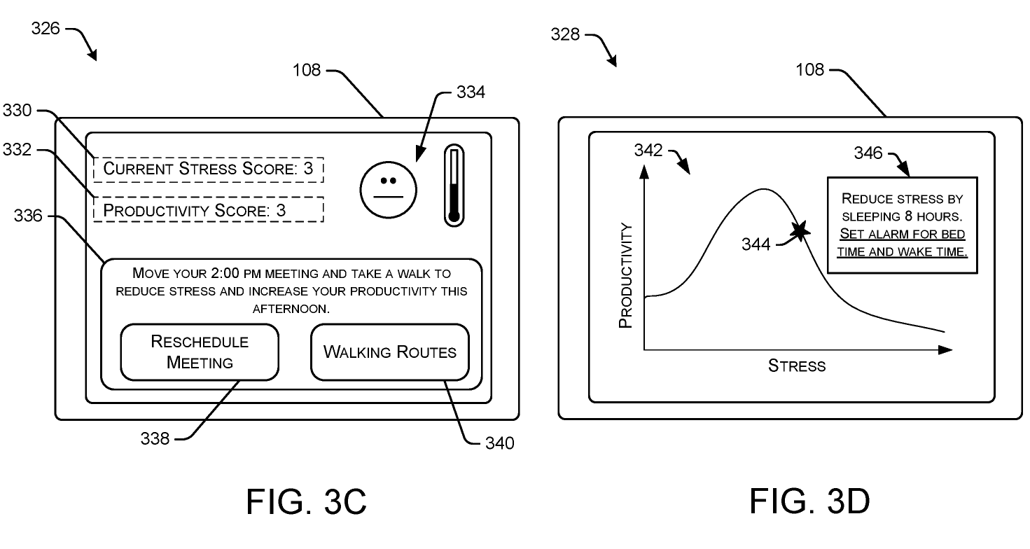

The output interface(s) 146 may enable the one or more devices 108 to present a user interface via a display 148 (e.g., touch screen, liquid crystal display (LCD), etc.). Additionally, and/or alternatively, the output interface(s) may enable the one or more devices 108 to output data via speakers or other output devices. FIG. 1 illustrates an example of a display 148 presenting an example of a user interface 150 configured to present stress and/or productivity insights and/or recommendations associated with determined stress and/or productivity insights to the user 106. Additional examples of user interfaces are described below with reference to FIGS. 3A and 3B.

FIG. 2 is a schematic diagram showing an example environment 200 for determining stress and productivity insights based on computerized data. Example environment 200 illustrates additional details associated with the example environment 100, described above with reference to FIG. 1. Example environment 200 may include a service provider 102, network(s) 104, and one or more devices 108 associated with a user 106, as described above with reference to FIG. 1. To illustrate various examples of the one or more devices that may be associated with the user 106, device 202A is illustrated as a tablet computing device, device 202B is illustrated as a desktop computing device, and device 202C is illustrated as a wearable computing device. Devices 202A, 202B, and/or 202C may represent a diverse variety of device types and are not limited to the particular types of devices illustrated in FIG. 2.

As described above with reference in FIG. 1, device(s) that may be included in the one or more servers 110 may include any type of computing device having processor(s) 112 operably connected to computer-readable media 114 such as via a bus, which in some instances may include one or more of a system bus, a data bus, an address bus, a PCI bus, a Mini-PCI bus, and any variety of local, peripheral, and/or independent buses. In at least one configuration, the computer-readable media 114 of the server(s) 110 may include module(s) for receiving data associated with the user 106, determining stress and productivity insights based on the data, and determining a recommendation based on the stress and productivity insights. Additional details associated with the data collection module 116 are described herein.

As described above, the data collection module 116 may be configured to access, receive, and/or determine data associated with the user 106. In at least one example, the data collection module 116 may access and/or receive data from the device(s) 108. In additional and/or alternative examples, the data collection module 116 may access and/or receive data from third party sources and/or systems. In some examples, the data collection module 116 may access data that is mapped to, or otherwise associated with, a user profile corresponding to a user 106 that is stored in the data store 130, described above with reference to FIG. 1. In at least one example, the data collection module 116 may leverage the sensor data 204, application data 206, etc. to determine productivity data and/or stress-related behavior data.

Personal data (e.g., sensor data 204, application data 206, etc.) must be acquired and used with utmost respect for the user's privacy. Accordingly, the personal data may be collected and/or provided to the service provider 102 subject to opt-in participation of the user 106. In examples where personal data is collected on the device(s) 108 and transmitted to the service provider 102 for processing, that personal data may be anonymized. In other examples, personal data may be confined to the device(s) 108, and only non-personal, summary data may be transmitted to the service provider 102.

Sensor data 204 may be data collected by one or more sensors 144 as described above with reference to FIG. 1. For example, sensor data 204 may include galvanic skin response sensor data indicating galvanic skin response measurements, skin temperature sensor data indicating temperatures on the surface of the skin, EEG data indicating electrical activity of the brain, ECG and/or EKG data indicating electrical activity of the heart, image data associated with eye movement, facial expressions, pupil dilation and/or contraction, etc., sound data associated with speech, etc. In some examples, the sensor data 204 may include accelerometer data indicating movement in multiple directions, gyroscope data indicating orientation and rotation, altimeter data indicating altitude, etc.

The sensor data 204 may be used to determine other types of data. For instance, EEG data, ECG and/or EKG data, accelerometer data, image data, etc. may be combined to determine sleep data 208. Sleep data 208 may indicate a sleep duration of the user 106, a sleep quality of the user 106, sleep cycles (e.g., REM, deep sleep, light sleep, etc.) of the user 106, etc. Additionally and/or alternatively, accelerometer data, gyroscope data, altimeter data, EEG data, skin temperature sensor data, etc. may be combined to generate fitness data 210. Fitness data 210 may indicate a number of steps taken by the user 106, a standing time of the user 106, a number of calories burned by the user 106, etc.

The application data 206 may include data associated with and/or collected by the one or more applications 140 described above with reference to FIG. 1. As described above, the application(s) 140 may include a fitness tracking application, a sleep tracking application, a nutrition tracking application, a health application, a messaging application, an email application, a calendar application, a social networking application, a web browser application, etc. Additional and/or alternative applications may be included in the application(s) 140. Data generated by the application(s) 140 may be referred to herein as application data 206.

The application data 206 may be used to determine other types of data. For instance, data associated with an email application may be used to determine email data 212. An email application enables users to send and receive emails. Email data 212 may indicate a number of emails sent and/or received, recipients of sent emails, senders of received emails, etc. Additionally, the email data 212 may indicate a time associated with sent and/or received emails, whether received emails were read, a time associated with when the emails were read, etc. In some examples, email data 212 may identify which emails were answered, deleted, stored, favorited, etc. Email data 212 may include patterns in sending and/or receiving emails. Moreover, the email data 212 may indicate a subject and/or a sentiment associated with individual emails (e.g., based on content in the subject line or the body of the email). For instance, various data processing techniques (e.g., semantic data processing, image recognition processing, etc.) may be used to process content in the subject line or the body of individual emails to determine the subject and/or sentiment associated with the individual emails.

Additionally and/or alternatively, data associated with a calendar application may be used to determine event data 214. Calendar applications enable users to add events to an electronic calendar, which may be synched between multiple devices (e.g., device 202A, device 202B, device 202C, etc.). Event data 214 may indicate a date, time, length, and/or location of an event scheduled in a user's calendar associated with the calendar application. Event data 214 may indicate participants of events, organizers of events, etc. In some examples, event data 214 may indicate whether an event is a personal event (e.g., doctor's appointment, spa appointment, sports event, party, etc.) or a business-related event (e.g., client meeting, conference, etc.). In at least one example, event data 214 may indicate whether an event is a recurring event. In some examples, event data 214 may indicate blocks of time where no event is scheduled.

Data associated with a nutrition application may be used to determine nutrition data 216. Nutrition applications enable users to track diet, calories, water intake, vitamin and/or mineral intake, etc. In some examples, users may input types of food they eat, quantities of the food they eat, times associated with when they eat, etc. Nutrition data 216 may indicate types of food the user 106 eats, quantities of the food the user 106 eats, times that the user 106 eats, etc. Additionally and/or alternatively, nutrition data 216 may indicate trends in the user's 106 diet, calories consumed by the user 106, amounts of water consumed by the user 106, vitamins and/or minerals consumed by the user 106, etc.

Data associated with a social networking application may be used to determine social data 218. Social networking applications enable users to connect with other users via a social network. Social data 218 may identify users that a user 106 is connected with via social networks, which users the user 106 interacts with via social networks, how the user 106 interacts with other users via the social networks, how frequently the user 106 interacts with the other users, etc. Data associated with a web browser application may be used to determine browsing data 220. Browsing data 220 may identify which websites a user 106 visits, how long the user 106 visits the websites, how frequently the user 106 switches between websites, etc. Additionally and/or alternatively, browsing data 220 may identify searches conducted by a user 106 and data associated with individual searches. For instance, the browsing data 220 may indicate the keyword(s) associated with individual search queries, timestamps associated with individual search queries, results returned responsive to individual search queries, etc.

In at least one example, the application data 206 may be used to determine activity data 222. For example, activity data 222 may identify which application(s) 140 a user 106 interacts with, how long the user 106 interacts with the application(s) 140, how frequently the user 106 switches between application(s) 140, etc. Moreover, activity data 222 may indicate which input interface(s) 142 and/or output interface(s) 146 a user 106 interacts with, how frequently the user 106 interacts with the input interface(s) 142 and/or output interface(s) 146, etc. For instance, activity data 222 may identify keyboard and/or mouse activity. In some examples, activity data 222 may identify time spent in screensaver/sleep mode.

In addition to receiving sensor data 204 and/or application data 206 from the device(s) 108, the data collection module 116 may receive communication data 224 from the device(s) 108. Communication data 224 may include call logs associated with calls (e.g., phone, video, etc.) made from and/or received by device 202A, device 202B, and/or device 202C. Additionally and/or alternatively, communication data 224 may include message logs associated with messages sent from and/or received by device 202A, device 202B, and/or device 202C. In at least one example, communication data 224 may identify participants to the calls and/or the messages, timestamps associated with the calls and/or the messages, date stamps associated with the calls and/or the messages, etc. In some examples, communication data 224 may indicate a sentiment associated with the calls and/or messages. For instance, various data processing techniques (e.g., semantic data processing, image recognition processing, etc.) may be used to process content associated with the calls and/or messages to determine the sentiment associated with the calls and/or messages.

In some examples, the data collection module 116 may receive location data 226 from the device(s) 108. In at least one example, device 202A, device 202B, and/or device 202C may include location systems (e.g., location sensors, motion sensors, etc.) configured to determine latitude, longitude, altitude, speed, etc. of device 202A, device 202B, and/or device 202C. Device 202A, device 202B, and/or device 202C may send location data indicative of latitude, longitude, altitude, speed, etc. to the data collection module 116. In at least some examples, location data 226 may indicate a length of time (e.g., commute time) required to travel between two or more locations, an average speed traveled between two or more locations, inactive time information, etc.

Additionally and/or alternatively, the data collection module 116 may receive environment data 228 from the device(s) 108. In at least one example, device 202A, device 202B, and/or device 202C may include systems configured to determine the temperature and/or humidity of the environment surrounding device 202A, device 202B, and/or device 202C. Moreover, device 202A, device 202B, and/or device 202C may include systems configured to determine levels of nitrogen dioxide, carbon monoxide, and/or other particulates, radiation, electromagnetic feedback, etc. present in the environment surrounding device 202A, device 202B, and/or device 202C. Environment data 228 may indicate the temperature and/or humidity of the environment surrounding a user 106, levels of nitrogen dioxide, carbon monoxide, and/or other particulates, electromagnetic feedback, etc. in the environment surrounding the user 106, etc. Environment data 228 may indicate metrics associated with light exposure, noise exposure, radiation exposure, etc. in the environment surrounding the user 106.

In addition to receiving data from the device(s) 108, the data collection module 116 may receive data from third party sources or systems. In some examples, the location data 226, environment data 228, etc. may be provided from third party sources or systems. Additionally, in at least one example, the data collection module 116 may receive electronic health record (EHR) data 230 from systems associated with clinicians involved in the care of the user 106 (so long as the user 106 has authorized the clinicians to release the EHR data 230). An EHR may be a digital version of a user's 106 paper medical chart. EHRs may include various types of information. For instance, EHRs may include administrative and billing information, demographic information, progress notes, vital signs, medical histories, diagnoses, medications, immunization dates, allergies, radiology images, lab and test results, etc. The information included in an EHR may correspond to EHR data 230. Additionally and/or alternatively, the data collection module 116 may receive genomic data 232 from third party sources or systems. Genomic data 232 may describe the genetic makeup of the user 106. Genomic data 232 may also identify correlations between particular genes and behaviors.

Additionally, in at least one example, the data collection module 116 may receive data from a work access monitoring system associated with an employer of a user 106. The work accessing monitoring system may provide work data 234 associated with the user 106. The work data 234 may include data associated with time entries associated with the user 106, work timesheets associated with the user 106, work schedules associated with the user 106, premises access information (e.g., security badge information) associated with the user 106, payroll information associated with the user 106, etc.

Moreover, in at least one example, the data collection module 116 may receive data input by the user 106 via an interface associated with the device 202A, device 202B, and/or device 202C. For instance, in some examples, the user 106 may input demographic data 236 via the interface. Demographic data 236 may include the name of the user 106, the address of the user 106, the gender of the user 106, the age of the user 106, the ethnicity of the user 106, the marital status of the user 106, the number of children the user 106 has, the education of the user 106, the profession of the user 106, financial information associated with the user 106, etc.

FIG. 3A is a schematic diagram showing an example user interface 300 for presenting stress insights via device(s) 108. FIG. 3A is a schematic diagram showing an example user interface 302 for presenting productivity insights via device(s) 108. FIGS. 3A and 3B illustrate two examples of user interfaces 300 and 302 that may be presented via device(s) 108 associated with a user 106. Additional and/or alternative content may be presented via various user interfaces. Additionally, additional and/or alternative configurations of content may be presented via various user interfaces.

As described above, the data processing module 118 may utilize a stress prediction model 124 to determine a stress score associated with a user 106. The stress score may represent stress associated with a user 106. A stress score is an example of a stress insight. Additionally and/or alternatively, the data processing module 118 may utilize a productivity prediction model 126 to determine a productivity score associated with a user 106. The productivity score may represent productivity of a user 106. A productivity score is an example of a productivity insight. User interfaces 300 and/or 302 may be configured to present stress scores and/or productivity scores to a user 106.

User interface 300 is a non-limiting example of how stress insights may be communicated to a user via a display of a device 108. In at least one example, the presentation module 138 may present user interface 300, which may communicate a current stress score associated with a user 106 via the user interface 300. The current stress score (1) may be presented to the user 106, as shown in box 304. In at least one example, the user interface 300 may include a calendar 306. In an example, the data processing module 118 may determine a stress score for individual time periods (e.g., hours of a day, days of the week, days and/or weeks of a month, etc.). As a non-limiting example, calendar 306 includes a section corresponding to each day of a week. Each day of the week is associated with a stress score (box 308) determined by the stress prediction model 124 based on productivity data and/or stress-related behavior data associated with the corresponding day. Additionally, the user interface 300 may include a graphic 310, symbol, or other representation, to visually indicate stress associated with each individual time period. Graphic 310 is a non-limiting example of a graphic, symbol, or other representation that may be used.

As described above, the recommendation module 120 may leverage a recommendation model 128 to determine recommendations based on stress and/or productivity insights. The recommendation module 120 may send recommendations to the communication module 136 and the presentation module 138 may determine how to present the recommendations to the user 106. FIG. 3A illustrates a recommendation (“go to bed early”) that is presented as a callout 312. As described above, the recommendation module 120 may determine actions that correspond to the recommendations and may send data associated with the actions to the communication module 136. The presentation module 138 may communicate the actions to the user 106. As a non-limiting example, the action associated with the recommendation to “go to bed early,” as illustrated in callout 312, is an action to set an alarm for bed time. In at least one example, actions may be associated with controls, hyperlinks, overlays, etc. that enable the user 106 to execute the actions items by interacting with the controls, hyperlinks, overlays, etc. For instance, the user 106 may interact with the hyperlink 314 that corresponds to setting an alarm and based at least in part on the interaction, the device 108 may access a clock application to enable the user 106 to set an alarm for when he or she should go to bed.

User interface 302 is a non-limiting example of how productivity insights may be communicated to a user via a display of a device 108. In at least one example, the presentation module 138 may present user interface 300, which may communicate a current productivity score associated with a user 106 via the user interface 300. The current productivity score (7) may be presented to the user 106, as shown in box 316. In at least one example, the user interface 300 may include a calendar 318. In an example, the data processing module 118 may determine a productivity score for individual time periods (e.g., hours of a day, days of the week, days and/or weeks of a month, etc.). As a non-limiting example, calendar 318 includes a section corresponding to each day of a week. Each day of the week is associated with a productivity score (box 320) determined by the productivity prediction model 126 based on productivity data and/or stress-related behavior data associated with the corresponding day. Additionally, the user interface 302 may include a graphic 322, symbol, or other representation, to visually indicate productivity associated with each individual time period. Graphic 322 is a non-limiting example of a graphic, symbol, or other representation that may be used.

As described above, the recommendation module 120 may leverage a recommendation model 128 to determine recommendations based on stress and/or productivity insights. The recommendation module 120 may send recommendations to the communication module 136 and the presentation module 138 may determine how to present the recommendations to the user 106. FIG. 3B illustrates a recommendation 324 (“Workout tomorrow morning to increase your productivity for the day.”) that is presented via the user interface 302. As described above, the recommendation module 120 may determine actions that correspond to the recommendations and may send data associated with the actions to the communication module 136. The presentation module 138 may communicate the actions to the user 106, as described above.

FIG. 3C is a schematic diagram showing an example user interface 326 for presenting stress insights and/or productivity insights—and a corresponding recommendation—via device(s) 108. FIG. 3D is a schematic diagram showing an example user interface 328 for presenting stress insights and/or productivity insights—and a corresponding recommendation—via device(s) 108. User interfaces 306 and 308 are additional non-limiting examples of how stress insights and productivity insights may be communicated to a user 106 via a display of a device 108. In at least one example, the presentation module 138 may present user interface 326, which may communicate a current stress score associated with a user 106 and a current productivity score associated with the user 106 via the user interface 326. The current stress score (3) may be presented to the user 106, as shown in box 330. The current productivity score (3) may be presented to the user 106, as shown in box 332. In at least one example, the user interface 326 may include graphics 334, symbols, or other representations, to visually indicate the current stress score and/or the current productivity score. Graphics 334 are non-limiting examples of graphics, symbols, or other representations that may be used.

As described above, the recommendation module 120 may leverage a recommendation model 128 to determine recommendations based on stress and/or productivity insights. The recommendation module 120 may send recommendations to the communication module 136 and the presentation module 138 may determine how to present the recommendations to the user 106. FIG. 3C illustrates a recommendation (“reschedule your 2:00 pm meeting and take a walk”) that is presented as a notification 336. As described above, the recommendation module 120 may determine actions that correspond to the recommendations and may send data associated with the actions to the communication module 136. The presentation module 138 may communicate the actions to the user 106. As a non-limiting example, the action associated with the recommendation to “reschedule your 2:00 pm meeting and take a walk,” as illustrated in notification 336, is an action to reschedule the meeting. In at least one example, actions may be associated with controls, hyperlinks, overlays, etc. that enable the user 106 to execute the actions by interacting with the controls, hyperlinks, overlays, etc. For instance, the user 106 may interact with control 338 that corresponds to rescheduling a meeting and based at least in part on the interaction, the device 108 may access a calendar application to enable the user 106 to reschedule his or her meeting. Additionally, the user 106 may interact with a second control 340 to access maps, directions, etc. regarding a walking route.

User interface 328 may communicate stress and productivity insights to a user 106. In at least one example, the presentation module 138 may present user interface 328, which may communicate relationships between stress and productivity via a graph 342. In such examples, the graph 342 may depict a parabola that represents relationships between stress and productivity that are specific to the user 106, a cohort of users (including the user 106), or a population of users (including the user 106). In at least one example, user interface 328 may communicate a current stress level and a current productivity level of a user 106 by a graphic, such as graphic 344, that is positioned within the graph 342. Graphic 344 is a non-limiting example of a graphic, symbol, or other representation that may be used to visually represent a current stress level and current productivity level of the user 106.

As described above, the recommendation module 120 may leverage a recommendation model 128 to determine recommendations based on stress and/or productivity insights. The recommendation module 120 may send recommendations to the communication module 136 and the presentation module 138 may determine how to present the recommendations to the user 106. FIG. 3D illustrates a recommendation (“sleep 8 hours”) that is presented as a notification 346. As described above, the recommendation module 120 may determine actions that correspond to the recommendations and may send data associated with the actions to the communication module 136. The presentation module 138 may communicate the actions to the user 106. As a non-limiting example, the action associated with the recommendation to “sleep 8 hours,” as illustrated in notification 346, is an action to set an alarm for bed time and wake time. In at least one example, actions may be associated with controls, hyperlinks, overlays, etc. that enable the user 106 to execute the actions items by interacting with the controls, hyperlinks, overlays, etc. For instance, the user 106 may interact with the words “set alarm for bed time and wake time,” which may be hyperlinked to an alarm clock application to enable the user 106 to set an alarm for bed time and wake time.

### Example Processes

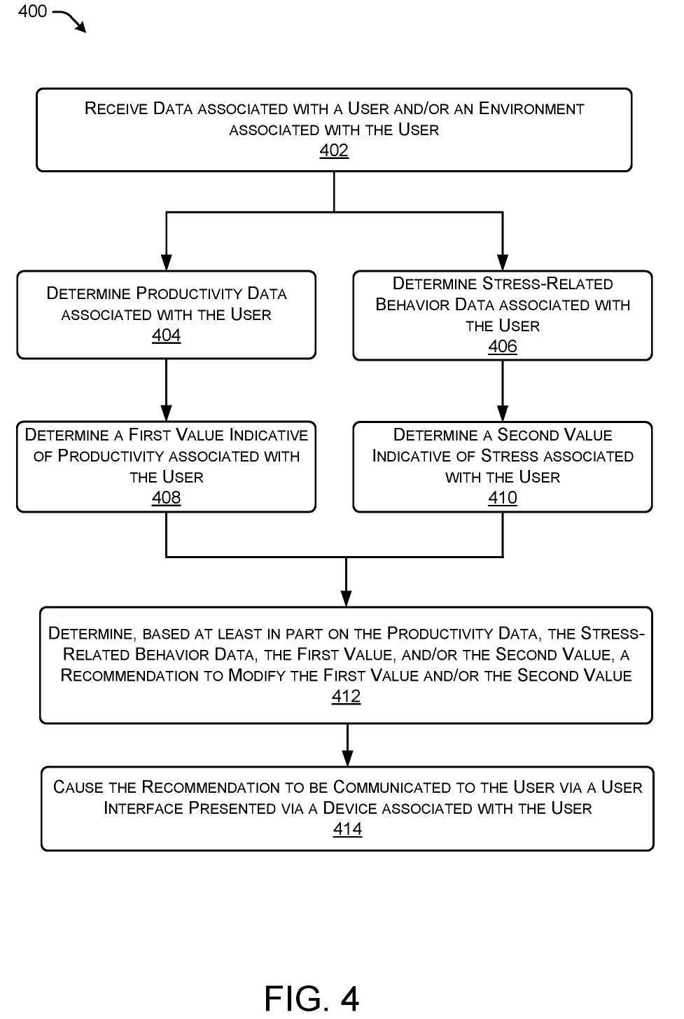

The processes described in FIGS. 4-6 below are illustrated as collections of blocks in logical flow graphs, which represent sequences of operations that may be implemented in hardware, software, or a combination thereof In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks may be combined in any order and/or in parallel to implement the processes.

FIG. 4 is a flow diagram that illustrates an example process 400 to determine a recommendation based on determined stress and productivity insights.

Block 402 illustrates receiving data associated with a user 106 and/or an environment associated with the user 106. The data collection module 116 may be configured to access, receive, and/or determine data associated with the user 106 and/or an environment associated with the user 106. In at least one example, the data collection module 116 may access and/or receive data from the device(s) 108 and/or third party sources and systems, as described above with reference to FIG. 2. In some examples, the data collection module 116 may access data that is mapped to, or otherwise associated with, a user profile corresponding to a user 106 that is stored in the data store 130, described above with reference to FIG. 1. Examples of data that the data collection module 116 may receive include sensor data 204, application data 206, sleep data 208, fitness data 210, email data 212, event data 214, nutrition data 216, social data 218, browsing data 220, activity data 222, communication data 224, location data 226, environment data 228, EHR data 230, genomic data 232, work data 234, and demographic data 236.

Block 404 illustrates determining productivity data associated with the user 106. Productivity data may by any type of data indicative of what a user 106 accomplishes and/or is capable of accomplishing. For example, productivity data may include email data 212, event data 214, social data 218, browsing data 220, activity data 222, communication data 224, location data 226, work data 234, etc. Additional details associated with email data 212, event data 214, social data 218, browsing data 220, activity data 222, communication data 224, location data 226, work data 234, etc. are described above with reference to FIG. 2.

Block 406 illustrates determining stress-related behavior data associated with the user 106. Stress-related behavior data may be any type of data that may cause stress for a user 106 and/or be indicative of the stress of a user 106. Examples of stress-related behavior data may include sensor data 204, sleep data 208, fitness data 210, email data 212, event data 214, nutrition data 216, social data 218, browsing data 220, activity data 222, communication data 224, location data 226, environment data 228, EHR data 230, genomic data 232, work data 234, demographic data 236, etc. Additional details associated with sensor data 204, sleep data 208, fitness data 210, email data 212, event data 214, nutrition data 216, social data 218, browsing data 220, activity data 222, communication data 224, location data 226, environment data 228, EHR data 230, genomic data 232, work data 234, and demographic data 236, etc. are described above with reference to FIG. 2.

Block 408 illustrates determining a first value indicative of productivity of the user 106. The data processing module 118 may include a productivity prediction model 126 for determining a value representative of productivity of a user 106 (e.g., productivity score). As described above, the productivity prediction model 126 may be a machine-learning algorithm trained to determine a productivity score of a user 106 based on various data inputs. At least one data input may include productivity data. In some examples, stress-related behavior data may be another data input. In at least one example, the productivity prediction model 126 may utilize at least some of the same data inputs as the stress prediction model 124. For instance, in at least one example, the productivity prediction model 126 may be applied to a data set associated with email data 212, event data 214, social data 218, browsing data 220, activity data 222, communication data 224, location data 226, work data 234, etc. In other examples, the productivity prediction model 126 may utilize different data inputs than the stress prediction model 124. The productivity prediction model 126 may account for certain data items that affect productivity more than other data items by weighting different data items differently. That is, in at least one example data items that affect productivity more than other data items may be associated with a larger weight than data items that have little or no effect on productivity. For instance, in a non-limiting example, event data 214 may be associated with a weight that is greater than another weight that is associated with social data 218. As described above, the output may be a productivity score associated with the user 106.

As a non-limiting example, event data 214 may indicate that a user 106 is scheduled with back-to-back meetings from 8:00 am to 4:00 pm and location data 226 may indicate that the user 106 is travelling. As a result, the productivity prediction model 126 may output a productivity score above a threshold or within a range of values indicating that the user 106 is being productive and/or is likely to be productive. That is, the user 106 appears to meeting with various people while travelling (and presumably being very productive in said meetings). Accordingly, the user 106 is likely to be productive and the productivity prediction model 126 may output a productivity score representative of such. As another non-limiting example, activity data 222 may indicate that a user 106 has been working in a single document for six hours, interacting with his or her keyboard at a particular frequency. Additionally, email data 212 may indicate that the user 106 has received 10 emails and has answered each email. As a result, the productivity prediction model 126 may output a productivity score above a threshold or within a range of values indicating that the user 106 is being productive and/or is likely to be productive. That is, the user 106 appears to working on a document and promptly answering emails. Accordingly, the user 106 is likely being productive and the productivity prediction model 126 may output a productivity score representative of such.

Block 410 illustrates determining a second value indicative of stress associated with the user 106. The data processing module 118 may include a stress prediction model 124 for determining a value representative of stress associated with a user 106 (e.g., a stress score). As described above, the stress prediction model 124 may be a machine-learning algorithm trained to determine a stress score of a user 106 based on various data inputs. At least one data input may include stress-related behavior data. In some examples, productivity data may be another data input. That is, in at least one example, the stress prediction model 124 may be applied to a data set associated with sensor data 204, sleep data 208, fitness data 210, email data 212, event data 214, nutrition data 216, social data 218, browsing data 220, activity data 222, communication data 224, location data 226, environment data 228, EHR data 230, genomic data 232, work data 234, demographic data 236, etc. In some examples, the stress prediction model 124 may account for certain data items that affect stress more than other data items by weighting different data items differently. For instance, data items that affect stress more than other data items may be associated with a larger weight than data items that have little or no effect on stress. For instance, in a non-limiting example, sleep data 204 may be associated with a weight that is greater than another weight that is associated with communication data 224. As described above, the stress prediction model 124 may output a stress score associated with the user 106.

As a non-limiting example, sleep data 208 may indicate that a user 106 slept four hours during each of the last three nights, email data 212 may indicate that the user 106 received 200 emails in the last 24 hours and over 100 of the emails are not answered, and work data 234 may indicate that the user 106 worked from 7:00 am to 11:00 pm each of the last three days. As a result, the stress prediction module 124 may output a stress score above a threshold or within a range of values indicating that the user 106 is stressed. That is, the user 106 appears to be sleeping very little, receiving a large number of emails—many of which he or she has not been able to answer, and working 16 hour days. Accordingly, the user 106 is likely to be stressed and the stress prediction model 124 may output a stress score representative of such. As another non-limiting example, event data 214 may indicate that a user 106 is planning to be out of the office for a vacation in three days, fitness data 210 may indicate that the user 106 has taken a fitness class each day of the last seven days, and nutrition data 216 may indicate that the user 106 has been eating regularly and consuming very little alcohol. As a result, the stress prediction module 124 may output a stress score below a threshold or within a range indicating that the user 106 is not stressed.

Block 412 illustrates determining, based at least in part on the productivity data, the stress-related behavior data, the first value, and/or the second value, a recommendation to modify the first value and/or the second value. As described above, in at least one example, the recommendation module 120 may determine recommendation(s) to decrease stress and/or increase productivity based at least in part on productivity data, stress-related behavior data, etc. In at least one example, the recommendation module 120 may leverage a recommendation model 128 to determine the recommendation(s). That is, in at least one example, the recommendation model 128 may be applied to a data set including productivity data, stress-related behavior data, the first value (i.e., productivity score), and/or the second value (i.e., stress score). The recommendation model 128 may output a recommendation to increase the first value and/or decrease the second value. A recommendation may correspond to a health activity that the user 106 can participate in, a change to an environment of the user 106, and/or a change to an activity that generates at least some productivity data to decrease stress and/or increase productivity. In additional and/or alternative examples, the recommendation module 120 may determine recommendation(s) to increase stress and/or increase productivity, decrease stress and/or decrease productivity, and/or increase stress and/or decrease productivity.

As an example, the recommendation model 128 may determine that the stress score associated with the user 106 is above a threshold, indicating that the user 106 is extremely stressed. Accordingly, the recommendation model 128 may leverage the productivity data and/or the stress-behavior data to determine what the user 106 has done, is doing, and/or intends to do. Based at least in part on determining that the stress score is above a threshold, the recommendation model 128 may identify a health activity that the user 106 can participate in, a change to an environment of the user 106, and/or a change to an activity that generates at least some productivity data to decrease the stress score. As stress may be coupled to productivity, by causing the stress score to decrease, the productivity score may also change (e.g., increase or decrease).

As an example, the recommendation model 128 may determine that the stress score associated with the user 106 is below a threshold, indicating that the user 106 is not stressed. Accordingly, the recommendation model 128 may leverage the productivity data and/or the stress-behavior data to determine what the user 106 has done, is doing, and/or intends to do. Based at least in part on determining that the stress score is below a threshold, the recommendation model 128 may identify a health activity that the user 106 can participate in, a change to an environment of the user 106, and/or a change to an activity that generates at least some productivity data to increase the stress score. As stress may be coupled to productivity, by causing the stress score to decrease, the productivity score may change (e.g., increase or decrease).

As an additional and/or alternative example, the recommendation model 128 may determine that the productivity score associated with the user 106 is below a threshold, indicating that the user 106 is not being productive. Accordingly, the recommendation model 128 may leverage the productivity data and/or the stress-behavior data to determine what the user 106 has done, is doing, and/or intends to do. Based at least in part on determining that the productivity score is below the threshold, the recommendation model 128 may identify a health activity that the user 106 can participate in, a change to an environment of the user 106, and/or a change to an activity that generates at least some productivity data to increase the productivity score. As productivity may be coupled to stress, by causing the productivity score to increase, the stress score may also change (e.g., increase or decrease).

Alternatively, the recommendation model 128 may determine that the productivity score associated with the user 106 is above a threshold, indicating that the user 106 is being productive (or being highly productive). Accordingly, the recommendation model 128 may leverage the productivity data and/or the stress-behavior data to determine what the user 106 has done, is doing, and/or intends to do. Based at least in part on determining that the productivity score is above the threshold, the recommendation model 128 may identify a health activity that the user 106 can participate in, a change to an environment of the user 106, and/or a change to an activity that generates at least some productivity data to decrease the productivity score. As productivity may be coupled to stress, by causing the productivity score to decrease, the stress score may also change (e.g., increase or decrease).

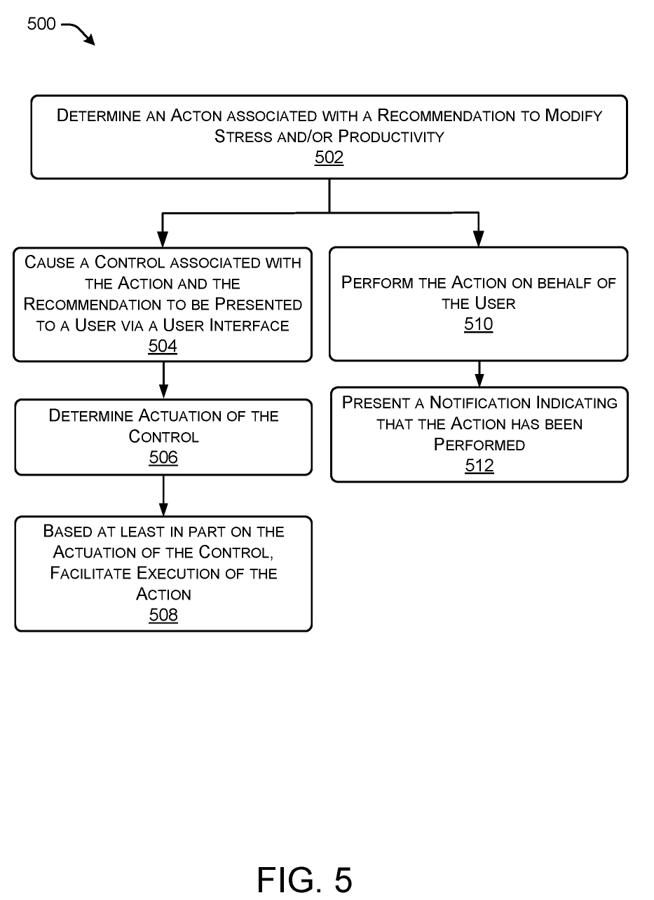

As described above, the recommendation module 120 may be configured to determine an action associated with a recommendation. Additional details associated with determining an action are described below with reference to FIG. 5. In at least one example, the recommendation module 120 may determine a time associated with a recommendation and/or action. In some examples, the recommendation module 120 may access an electronic calendar associated with a user 106 to determine the time associated with the recommendation and/or action. For instance, in some examples, a recommendation may be to schedule a yoga class at 2:00 pm or to go to bed at 9:00 pm to prepare for an upcoming day. Additionally and/or alternatively, the recommendation module 120 may determine a location associated with a recommendation and/or action. In some examples, the recommendation module 120 may access event data 214 and/or location data 226 to determine where a user 106 is, where the user 106 has been, and/or where the user 106 is planning to go. The recommendation module 120 may leverage the event data 214 and/or location data 226 for determining the location associated with the recommendation and/or action.

Block 414 illustrates causing the recommendation to be communicated to the user via a user interface presented via a device 108 associated with the user 106. The recommendation module 120 may send recommendations to the communication module 136 and the presentation module 138 may present the recommendations to the user 106. The recommendation module 120 may provide recommendations to the one or more devices 108 reactively (responsive to a request from a user 106 to determine a recommendation), proactively (without a request from a user 106), at a particular frequency, after a lapse of a predetermined period of time, etc. The presentation module 138 may present the recommendations as a taskbar tease, a push notification, an email, etc. In some examples, the presentation module 138 may present the recommendations at times associated with the recommendations and/or corresponding actions. Two non-limiting examples of user interfaces configured to present the recommendations and/or actions to the user 106 are described above with reference to FIGS. 3A and 3B.

FIG. 5 is a flow diagram that illustrates an example process 500 to facilitate execution of an action associated with a recommendation based on determined stress and productivity insights.

Block 502 illustrates determining an action associated with a recommendation to modify stress and/or productivity. As described above, the recommendation module 120 may be configured to determine an action associated with a recommendation. An action may effectuate the recommendation. That is, in at least one example, the recommendation module 120 may be configured to identify one or more aspects of a user's 106 health and/or environment that may be modified to decrease stress and/or increase productivity (or, increase stress and/or increase productivity, decrease stress and/or decrease productivity, increase stress and/or decrease productivity, etc.). In at least one example, the one or more aspects may be determined by accessing productivity data and/or stress-related behavior data associated with the user 106. In some examples, the one or more aspects may be determined based on previous behaviors of the user 106. In other examples, the one or more aspects may be determined based on previous behaviors of a cohort of users or a population of users. Based at least in part on identifying the one or more aspects of the user's 106 health and/or environment that may be modified, the recommendation module 120 may identify one or more actions that can affect a modification to said one or more aspects.

For instance, a recommendation may be to schedule a yoga class at 2:00 pm. A corresponding action may be scheduling the yoga class, which can be done via an online resource. In some examples, the recommendation module 120 may leverage data associated with the user 106 (e.g., email data 212, event data 214, social data 218, location data 226, etc.) to recommend a particular yoga studio. For instance, the recommendation module 120 may mine the email data 212, event data 214, or social data 218 to determine which yoga studio the user 106 regularly attends. Or, the recommendation module 120 may leverage location data 226 to identify a yoga studio that is geographically close to the user 106 (for instance, if the user 106 travelling). In another example, a recommendation may be to clear some space in the user's calendar at a particular time to enable the user to work for an uninterrupted period of time. A corresponding action may be to cancel or reschedule an event scheduled in the user's calendar at the particular time.

Block 504 illustrates causing a control corresponding to the action and the recommendation to be presented to a user 106 via a user interface. In some examples, the action may be associated with an application (e.g., application(s) 140) or other resource such that an action may be effectuated by actuation of the control. The presentation module 138 may present a control (or hyperlink, overlay, etc.) with the recommendation via the user interface. For instance, in the yoga example described above, the presentation module 138 may present a control (or hyperlink, overlay, etc.) that is linked to a scheduling feature of a yoga studio with the recommendation so that the user 106 can schedule a yoga class. Or, in the calendar example described above, the presentation module 138 described above may present a control (or hyperlink, overlay, etc.) that is linked to a calendar application so that the user 106 can cancel or reschedule his or her event.

Block 506 illustrates determining actuation of the control. The presentation module 138 may determine actuation of the control (or hyperlink, overlay, etc.). That is, in at least one example, the presentation module 138 may determine that a user 106 interacts with the control (or hyperlink, overlay, etc.) by clicking the control (or hyperlink, overlay, etc.), tapping the control (or hyperlink, overlay, etc.), hovering over the control (or hyperlink, overlay, etc.), pointing at the control (or hyperlink, overlay, etc.), gazing at the control (or hyperlink, overlay, etc.), speaking the control, etc.

Block 508 illustrates based at least in part on the actuation of the control, facilitating execution of the action. Based at least in part on the actuation of the control, the user 106 may be directed to the application (e.g., application(s) 140) or other resource associated with the control (or hyperlink, overlay, etc.). Accordingly, based at least in part on the actuation of the control, the user 106 may execute the action, thereby effectuating a change in a health activity that the user 106 can participate in, a change to an environment of the user 106, and/or a change to an activity that generates at least some productivity data in an effort to decrease stress and/or increase productivity.

Block 510 illustrates performing the action on behalf of the user 106. In at least additional and/or alternative examples, a device 108 may perform the action on behalf of the user 106. For instance, in at least one example, an action may be associated with utilizing an application (e.g., application(s) 140) to adjust the temperature of the environment surrounding the user 106. In such an example, the device 108 may adjust the temperature of the environment on behalf of the user 106. Or, the device 108 may move a meeting in an electronic calendar on behalf of the user 106. That is, the user 106 may not need to interact with the device 108 to cause the action to be performed.

Block 512 illustrates presenting a notification indicating that the action has been performed. Based at least in part on performing the action, the presentation module 138 may present a notification via the user interface to communicate to the user 106 that the action has been performed.

In some examples, the device 108 may present the recommendations and/or notifications in a modality and/or communication style that is personal to the user 106 and/or users like a user 106. For instance, in at least one example, the presentation module 138 may leverage preferences of the user 106 and/or other users like the user 106 in determining whether to perform the action on behalf of the user 106 or present the control associated with the action to the user 106 via the user interface. Additionally and/or alternatively, the presentation module 138 may leverage preferences of the user 106 and/or other users like the user 106 in determining the tone, configuration, timing, etc. associated with the recommendations and/or notifications.

FIG. 6 is a flow diagram that illustrates a process 600 for providing feedback to update a recommendation model for determining recommendations based on determined stress and productivity insights.

Block 602 illustrates determining that a user 106 accepts a recommendation to modify stress and/or productivity. In at least one example, the feedback module 122 may determine whether a user 106 accepts a recommendation. In some examples, the feedback module 122 may determine that a user 106 accepts a recommendation based at least in part on determining that the user 106 actuated a control (or hyperlink, overlay, etc.) associated with an action corresponding to a recommendation, as described above. In other examples, the feedback module 122 may infer that a user 106 accepts a recommendation based at least in part on accessing data associated with the user 106 and/or the environment associated with the user 106 (e.g., sensor data 204, application data 206, sleep data 208, fitness data 210, email data 212, event data 214, nutrition data 216, social data 218, browsing data 220, activity data 222, communication data 224, location data 226, environment data 228, EHR data 230, genomic data 232, work data 234, demographic data 236, etc.). For instance, the feedback module 122 may access sleep data 208 and may verify that a user 106 slept eight hours, which is consistent with a recommendation to sleep eight hours. Or, the feedback module 122 may access event data 214 and may verify that a user 106 ran three miles at 2:00 pm, which is consistent with a recommendation to run three miles at 2:00 pm.

In some examples, the feedback module 122 may prompt a user 106 for explicit feedback indicating whether the user 106 accepted the recommendation. For example, at a time after the presentation module 138 presented the recommendation to the user 106, the feedback module 122 may cause a request for feedback to be presented to the user 106. In a non-limiting example, the feedback module 122 may cause a user interface to be presented to the user 106 prompting the user 106 to indicate whether he or she accepted the recommendation. Or, in another non-limiting example, the feedback module 122 may cause a virtual assistant (e.g., SIRI®, CORTANA®, ALEXA®, etc.) to ask the user 106 whether he or she accepted the recommendation.

Block 604 illustrates determining updated productivity data. As described above, productivity data may by any type of data indicative of what a user 106 accomplishes. For example, productivity data may include email data 212, event data 214, social data 218, browsing data 220, activity data 222, communication data 224, location data 226, work data 234, etc. In at least one example, the data collection module 116 may receive updated email data 212, updated event data 214, updated social data 218, updated browsing data 220, updated activity data 222, updated communication data 224, updated location data 226, updated work data 234, etc. The data collection module 116 may determine updated productivity data based at least in part on any of the updated data received.

Block 606 illustrates determining updated stress-related behavior data. As described above, stress-related behavior data may be any type of data that may cause stress for a user 106. Examples of stress-related behavior data may include sensor data 204, sleep data 208, fitness data 210, email data 212, event data 214, nutrition data 216, social data 218, browsing data 220, activity data 222, communication data 224, location data 226, environment data 228, EHR data 230, genomic data 232, work data 234, demographic data 236, etc. In at least one example, the data collection module 116 may receive updated sensor data 204, updated sleep data 208, updated fitness data 210, updated email data 212, updated event data 214, updated nutrition data 216, updated social data 218, updated browsing data 220, updated activity data 222, updated communication data 224, updated location data 226, updated environment data 228, updated EHR data 230, updated genomic data 232, updated work data 234, updated demographic data 236, etc. The data collection module 116 may determine updated stress-related behavior data based at least in part on any of the updated data received.

Block 608 illustrates determining an updated value indicative of productivity of the user. The data processing module 118 may include a productivity prediction model 124 for determining a value representative of productivity of a user 106 (e.g., productivity score). The productivity prediction module 126 may be applied to a data set associated with the updated data and may determine an updated productivity score associated with the user 106.

Block 610 illustrates determining an updated value indicative of stress associated with the user. The data processing module 118 may include a stress prediction model 124 for determining a value representative of stress associated with a user 106 (e.g., stress score). The stress prediction module 124 may be applied to a data set associated with the updated data and may determine an updated stress score associated with the user 106.

Block 612 illustrates comparing the updated value indicative of stress and the updated value indicative of productivity with previously determined values indicative of stress and productivity. In at least one example, the feedback module 122 may compare a previous stress score with the updated stress score to determine whether the recommendation affected the stress score. Additionally and/or alternatively, the feedback module 122 may compare a previous productivity score with the updated productivity score to determine whether the recommendation affected the productivity score.

Block 614 illustrates determining feedback data based at least in part on an effectiveness of the recommendation. The feedback module 122 may determine feedback data based at least in part on how the updated stress score and productivity score compare with the previous stress score and previous productivity score, respectively. For instance, if a recommendation intended to decrease stress and increase productivity, based at least in part on determining that the updated stress score is less than the previous stress score and/or the updated productivity score is greater than the previous productivity score, the feedback module 122 may determine that the recommendation was effective. Accordingly, the feedback module 122 may generate feedback data indicating that the recommendation was effective for decreasing stress and/or increasing productivity. In some examples, the feedback module 122 may compare the updated stress score and updated productivity score with the previous stress score and previous productivity score, respectively, and may quantify how the updated stress score and updated productivity score compare with the previous stress score and previous productivity score, respectively. That is, the feedback module 122 may determine an extent (e.g., quantity, percentage, etc.) to which the recommendation resulted in a decrease of the stress score and/or an increase of the productivity score. The feedback module 122 may generate feedback data indicating the extent to which the recommendation decreased the stress score and/or increased the productivity score.

Alternatively, in the example above where the recommendation intended to decrease stress and increase productivity, the feedback module 122 may determine that the updated stress score is greater than the previous stress score and/or the updated productivity score is less than the previous productivity score. Accordingly, the feedback module 122 may determine that the recommendation was not effective. In such an example, the feedback module 122 may generate feedback data indicating that the recommendation was not effective for decreasing stress and/or increasing productivity. In some examples, the feedback data may indicate an extent to which the recommendation affected the previous stress score and/or previous productivity score.

Block 616 illustrates updating a recommendation model based at least in part on the feedback data. The feedback module 122 may provide the feedback data to the recommendation module 120 to update the recommendation model 124. That is, the recommendation module 120 may leverage whether a recommendation was effective to improve which recommendations it makes to users to modify stress and/or productivity.

A. A system comprising: one or more processors; and memory that stores instructions that are executable by the one or more processors to cause the system to perform operations comprising: determining productivity data associated with a user; receiving sensor data associated with the user; determining, based at least in part on the sensor data, stress-related behavior data associated with the user; inferring, based at least in part on the stress-related behavior data, a first value indicative of stress associated with the user; inferring, based at least in part on the productivity data, a second value indicative of productivity of the user; determining a recommendation to at least one of decrease the first value or increase the second value; and causing an action to be performed such to effectuate the recommendation.

B. A system as paragraph A recites, wherein the recommendation is associated with a health activity.

C. A system as either paragraphs A or B recite, wherein the recommendation is associated with a change to an environment associated with the user.

D. A system as any of paragraphs A-C recite, wherein the recommendation is associated with a change to an activity that generates at least part of the productivity data.

E. A system as any of paragraphs A-D recite, wherein the recommendation is associated with a reduction in an amount of time that the user interacts with a display of a device associated with the user.

F. A system as any of paragraphs A-E recite, the operations further comprising: causing a control corresponding to the action and the recommendation to be presented via a device associated with the user; determining an actuation of the control; and based at least in part on the actuation of the control, facilitating execution of the action.

G. A system as any of paragraphs A-F recite, the operations further comprising: causing the action to be performed on behalf of the user; and causing a notification to be presented via a device associated with the user, the notification indicating that the action has been performed.

H. A computer-implemented method for leveraging productivity data and stress-related behavior data to determine recommendations associated with at least one of a health activity or a change to an environment, the computer-implemented method comprising: receiving data associated with a user; determining, based at least in part on the data, the productivity data associated with the user; determining, based at least in part on the data, the stress-related behavior data associated with the user; inferring, based at least in part on the stress-related behavior data, a first value indicative of stress associated with the user; inferring, based at least in part on the productivity data, a second value indicative of productivity of the user; determining, based on at least one of the first value or the second value, a recommendation of the recommendations associated with at least one of a health activity or a change to an environment associated with the user; and causing a user interface configured to communicate the recommendation to the user to be presented via a device associated with the user.

I. A computer-implemented method as paragraph H recites, wherein the productivity data comprises at least one of email data, event data, social data, browsing data, activity data, communication data, location data, or work data.

J. A computer-implemented method as either paragraph H or I recites, further comprising receiving sensor data from one or more sensors associated with the device, the sensor data being used to determine at least one of a heart rate of the user, a skin temperature of the user, a galvanic skin response of the user, or a distance traveled by the user.

K. A computer-implemented method as paragraph J recites, further comprising determining the stress-related behavior data based at least in part on the sensor data.

L. A computer-implemented method as any of paragraphs H-K recite, wherein the stress-related behavior data comprises at least one of sleep data, fitness data, email data, event data, nutrition data, social data, browsing data, activity data, communication data, location data, environment data, electronic health record data, genomic data, work data, or demographic data.

M. A computer-implemented method as any of paragraphs H-L recite, wherein the device associated with the user comprises a wearable device.

N. A computer-implemented method as any of paragraphs H-M recite, wherein determining the recommendation is based at least in part on: determining that the first value is above a threshold; and determining, based on at least one of the productivity data or the stress-related behavior data, at least one of the health activity or the change to the environment associated with the user that may be modified to decrease the first value.

O. A computer-implemented method as any of paragraphs H-N recite, wherein determining the recommendation is based at least in part on: determining that the second value is below a threshold; and determining, based on at least one of the productivity data or the stress-related behavior data, at least one of the health activity or the change to the environment associated with the user that may be modified to increase the second value.

P. A computer-implemented method as any of paragraphs H-O recite, further comprising: determining that the user accepts the recommendation; determining updated productivity data; determining updated stress-related behavior data; determining, based at least in part on the updated stress-related behavior data, a third value indicative of stress associated with the user; determining, based at least in part on the updated productivity data, a fourth value indicative of productivity of the user; and comparing the first value with the third value and the second value with the fourth value to determine an effectiveness of the recommendation.

Q. A computer-implemented method as paragraph P recites, further comprising updating a model for determining recommendations based at least in part on the effectiveness of the recommendation.

R. One or more computer-readable media encoded with instructions that, when executed by a processor, configure a computer to perform a method as any of paragraphs H-P recite.

S. A device comprising one or more processors and one or more computer readable media encoded with instructions that, when executed by the one or more processors, configure a computer to perform a computer-implemented method as any of paragraphs H-P recite.

T. A computer-implemented method for leveraging productivity data and stress-related behavior data to determine recommendations associated with at least one of a health activity or a change to an environment, the computer-implemented method comprising: means for receiving data associated with a user; means for determining, based at least in part on the data, the productivity data associated with the user; means for determining, based at least in part on the data, the stress-related behavior data associated with the user; means for inferring, based at least in part on the stress-related behavior data, a first value indicative of stress associated with the user; means for inferring, based at least in part on the productivity data, a second value indicative of productivity of the user; means for determining, based on at least one of the first value or the second value, a recommendation of the recommendations associated with at least one of a health activity or a change to an environment associated with the user; and means for causing a user interface configured to communicate the recommendation to the user to be presented via a device associated with the user.

U. A computer-implemented method as paragraph T recites, wherein the productivity data comprises at least one of email data, event data, social data, browsing data, activity data, communication data, location data, or work data.

V. A computer-implemented method as either paragraph T or U recites, further comprising means for receiving sensor data from one or more sensors associated with the device, the sensor data being used to determine at least one of a heart rate of the user, a skin temperature of the user, a galvanic skin response of the user, or a distance traveled by the user.

W. A computer-implemented method as paragraph V recites, further comprising means for determining the stress-related behavior data based at least in part on the sensor data.

X. A computer-implemented method as any of paragraphs T-W recite, wherein the stress-related behavior data comprises at least one of sleep data, fitness data, email data, event data, nutrition data, social data, browsing data, activity data, communication data, location data, environment data, electronic health record data, genomic data, work data, or demographic data.

Y. A computer-implemented method as any of paragraphs T-X recite, wherein the device associated with the user comprises a wearable device.

Z. A computer-implemented method as any of paragraphs T-Y recite, wherein determining the recommendation is based at least in part on: determining that the first value is above a threshold; and determining, based on at least one of the productivity data or the stress-related behavior data, at least one of the health activity or the change to the environment associated with the user that may be modified to decrease the first value.

AA. A computer-implemented method as any of paragraphs T-Z recite, wherein determining the recommendation is based at least in part on: determining that the second value is below a threshold; and determining, based on at least one of the productivity data or the stress-related behavior data, at least one of the health activity or the change to the environment associated with the user that may be modified to increase the second value.

AB. A computer-implemented method as any of paragraphs T-AA recite, further comprising: means for determining that the user accepts the recommendation; means for determining updated productivity data; means for determining updated stress-related behavior data; means for determining, based at least in part on the updated stress-related behavior data, a third value indicative of stress associated with the user; means for determining, based at least in part on the updated productivity data, a fourth value indicative of productivity of the user; and means for comparing the first value with the third value and the second value with the fourth value to determine an effectiveness of the recommendation.

AC. A computer-implemented method as paragraph AB recites, further comprising means for updating a model for determining recommendations based at least in part on the effectiveness of the recommendation.

AD. A device comprising: one or more applications; one or more processors; and memory that stores one or more instructions that are executable by the one or more processors to cause the device to perform operations comprising: receiving, from the one or more applications, application data associated with the device; determining, based at least in part on the application data, productivity data associated with the user; receiving, from one or more sensors, sensor data associated with a user; determining, based at least in part on at least one of the application data or the sensor data, stress-related behavior data associated with the user; determining, based at least in part on at least one of the productivity data or the stress-related behavior data, a recommendation associated with at least one of a health activity or a change to an environment associated with the user; and presenting the recommendation to the user via a user interface configured to communicate at least one of stress associated with the user or predicted productivity of the user.

AE. A device as paragraph AD recites, the operations further comprising presenting, with the recommendation and via the user interface, a control corresponding to an action associated with the recommendation, wherein actuation of the control enables execution of the action.

AF. A device as either of paragraphs AD or AE recite, the operations further comprising controlling a power state of the system based at least in part on the recommendation.

### Conclusion

Although the subject matter has been described in language specific to structural features and/or methodological acts, it is to be understood that the subject matter defined in the appended claims is not necessarily limited to the specific features or acts described. Rather, the specific features and acts are described as illustrative forms of implementing the claims.

Conditional language such as, among others, “may,” “could,” “might” or “may,” unless specifically stated otherwise, are understood within the context to present that certain examples include, while other examples do not necessarily include, certain features, elements and/or steps. Thus, such conditional language is not generally intended to imply that certain features, elements and/or steps are in any way required for one or more examples or that one or more examples necessarily include logic for deciding, with or without input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

What is claimed is:

1. A system comprising:
one or more processors; and
memory that stores instructions that are executable by the one or more processors to cause the system to perform operations comprising:
determining productivity data associated with a user;
receiving sensor data associated with the user;
determining, based at least in part on the sensor data, stress-related behavior data associated with the user;
inferring, based at least in part on the stress-related behavior data, a first value indicative of stress associated with the user;
inferring, based at least in part on the productivity data, a second value indicative of productivity of the user;
determining a recommendation to at least one of decrease the first value or increase the second value; and
causing an action to be performed such to effectuate the recommendation.

2. A system as claim 1 recites, wherein the recommendation is associated with a health activity.

3. A system as claim 1 recites, wherein the recommendation is associated with a change to an environment associated with the user.

4. A system as claim 1 recites, wherein the recommendation is associated with a change to an activity that generates at least part of the productivity data.

5. A system as claim 1 recites, wherein the recommendation is associated with a reduction in an amount of time that the user interacts with a display of a device associated with the user.

6. A system as claim 1 recites, the operations further comprising:
causing a control corresponding to the action and the recommendation to be presented via a device associated with the user;
determining an actuation of the control; and
based at least in part on the actuation of the control, facilitating execution of the action.

7. A system as claim 1 recites, the operations further comprising:
causing the action to be performed on behalf of the user; and
causing a notification to be presented via a device associated with the user, the notification indicating that the action has been performed.

8. A computer-implemented method comprising:
determining productivity data associated with a user;
determining stress-related behavior data associated with the user;
inferring, based at least in part on the stress-related behavior data, a first value indicative of stress associated with the user;
inferring, based at least in part on the productivity data, a second value indicative of productivity of the user;
determining, based on at least one of the first value or the second value, a recommendation associated with at least one of a health activity or a change to an environment associated with the user; and
causing a user interface configured to communicate the recommendation to the user to be presented via a device associated with the user.

9. A computer-implemented method as claim 8 recites, wherein the productivity data comprises at least one of email data, event data, social data, browsing data, activity data, communication data, location data, or work data.

10. A computer-implemented method as claim 8 recites, further comprising receiving sensor data from one or more sensors associated with the device, the sensor data being used to determine at least one of a heart rate of the user, a skin temperature of the user, a galvanic skin response of the user, or a distance traveled by the user.

11. A computer-implemented method as claim 10 recites, further comprising determining the stress-related behavior data based at least in part on the sensor data.

12. A computer-implemented method as claim 8 recites, wherein the stress-related behavior data comprises at least one of sleep data, fitness data, email data, event data, nutrition data, social data, browsing data, activity data, communication data, location data, environment data, electronic health record data, genomic data, work data, or demographic data.

13. A computer-implemented method as claim 8 recites, wherein the device associated with the user comprises a wearable device.

14. A computer-implemented method as claim 8 recites, wherein determining the recommendation is based at least in part on:
determining that the first value is above a threshold; and
determining, based on at least one of the productivity data or the stress-related behavior data, at least one of the health activity or the change to the environment associated with the user that may be modified to decrease the first value.

15. A computer-implemented method as claim 8 recites, wherein determining the recommendation is based at least in part on:
determining that the second value is below a threshold; and
determining, based on at least one of the productivity data or the stress-related behavior data, at least one of the health activity or the change to the environment associated with the user that may be modified to increase the second value.

16. A computer-implemented method as claim 8 recites, further comprising:
determining that the user accepts the recommendation;
determining updated productivity data;
determining updated stress-related behavior data;
determining, based at least in part on the updated stress-related behavior data, a third value indicative of stress associated with the user;
determining, based at least in part on the updated productivity data, a fourth value indicative of productivity of the user; and
comparing the first value with the third value and the second value with the fourth value to determine an effectiveness of the recommendation.

17. A computer-implemented method as claim 16 recites, further comprising updating a model for determining recommendations based at least in part on the effectiveness of the recommendation.

18. A device comprising:
one or more applications;
one or more processors; and
memory that stores one or more instructions that are executable by the one or more processors to cause the device to perform operations comprising:
receiving, from the one or more applications, application data associated with the device;
determining, based at least in part on the application data, productivity data associated with the user;
receiving, from one or more sensors, sensor data associated with a user;
determining, based at least in part on at least one of the application data or the sensor data, stress-related behavior data associated with the user;
determining, based at least in part on at least one of the productivity data or the stress-related behavior data, a recommendation associated with at least one of a health activity or a change to an environment associated with the user; and
presenting the recommendation to the user via a user interface configured to communicate at least one of stress associated with the user or predicted productivity of the user.

19. A device as claim 18 recites, the operations further comprising presenting, with the recommendation and via the user interface, a control corresponding to an action associated with the recommendation, wherein actuation of the control enables execution of the action.

20. A device as claim 18 recites, the operations further comprising controlling a power state of the system based at least in part on the recommendation.
